(19) United States
(12) Patent Application Publication
(10) Pub. No.: US 2012/0205280 A1
(43) Pub. Date: Aug. 16, 2012

(54) PROCESS FOR PRODUCING A CONTAINER AND SUCH A CONTAINER

(75) Inventors: Francesc Ayats Ardite, Barcelona (ES); Axel Halbherr, Ludwigshafen (DE); Frederic Moreux, Mazowiecki (PL)

(73) Assignee: Reckitt Benckiser N.V., WT Hoofddorp (NL)

(21) Appl. No.: 13/392,163

(22) PCT Filed: Aug. 25, 2010
(86) PCT No.: PCT/GB10/51404

§ 371 Date: Apr. 18, 2012

(30) Foreign Application Priority Data
Sep. 2, 2009 (GB) 0915234.9

(51) Int. Cl. B29C 51/00; B65D 1/00; B65D 85/00; B28B 1/48

(52) U.S. Cl. 206/525; 264/154; 264/155; 220/604

(57) ABSTRACT

A process for producing a container comprising at least one aperture, the process comprising the steps of:
a) thermoforming a material to produce an intermediate container in a mould,
b) supporting at least a portion of the intermediate container with a supporting means,
c) securing the intermediate container to hold it in a fixed locus in contact with the supporting means,
d) forming at least one aperture in a surface of the intermediate container in an area of the intermediate container adjacent to the portion of the intermediate container supported by the supporting means to produce the container,
   and wherein the supporting means provides sufficient support to the intermediate container to prevent substantial deformation thereof during at step (d). A container produced by the method is also provided.

The present invention relates to process for producing a container.

Containers of thermoplastic materials are generally made using injection moulding or thermoforming processes.

Injection moulding provides a high degree of flexibility in the shape of the container that may be produced. However, the equipment required for injection moulding is complex and expensive as the overall process involves a high number of individual steps. Furthermore the last stage of the process (the injection step itself) requires the use of a high pressure with its associated risks. Additionally containers produced in this way tend to be relative thick meaning that a high amount of container material is used. This is undesirable from an economical viewpoint, makes the containers somewhat heavier and may limit the shapes which can be produced.

Thermoforming is more advantageous in that the overall production process is simpler and therefore cheaper than injection moulding. However, thermoforming does not readily lend itself to the production of overly complex/intricate containers. This is especially an issue for containers which are required to have one or more apertures located therein. These apertures cannot generally be added during the thermoforming process itself but need to be added subsequently; thus increasing the number of processing steps. Since thermoformed containers usually have a low rigidity the aperture adding process generally suffers from a low degree of accuracy/efficacy which can lead to a lower quality container.

It is an object of the invention to address one or more of the aforementioned problems. In particular it is an object of the present invention to provide an improved container formation process.

According to a first aspect of the invention there is provided a process for producing a container comprising at least one aperture, the process comprising the steps of:
a) thermoforming a material to produce an intermediate container in a mould,
b) supporting at least a portion of the intermediate container with a supporting means,
c) securing the intermediate container to hold it in a fixed locus in contact with the supporting means,
d) forming at least one aperture in a surface of the intermediate container in an area of the intermediate container adjacent to the portion of the intermediate container supported by the supporting means to produce the container,
   and wherein the supporting means provides sufficient support to the intermediate container to prevent substantial deformation thereof during step (d).

The process of the invention provides for improved container production to be made possible. It has been found that apertures may be added to intermediate containers produced in a thermoforming process with a high degree of accuracy in both their location and size. Additionally reduced distortion/disruption of the intermediate container is observed in the aperture forming stage. The overall effect is that high quality containers can be produced by the process of the present invention.

Preferably the mould used to produce the intermediate container in the thermoforming process of step a) comprises a plurality of recessions and a circumferential planar section (flange). Thus (from co-operation with the mould) preferably the intermediate container, and thus the final container, comprises a number of chambers and a circumferential flange. Overall the container generally resembles a planar sheet having a number of chambers (recessions when viewed from above the planar sheet surface) present therein.

The chambers are preferably equally sized and shaped. It is preferred that the chambers in the containers have a rectangular opening (at the planar surface of the container). It is also preferred that the chambers have a maximum depth dimension which is greater than their maximum width dimension (depth being measured in the axis projecting away from the planar surface of the container and width being measured along the axis of the planar surface of the container). It has been found previously that without using the process of the present invention to produce containers it can be difficult to produce chambers which are deeper than they are wide (at their maximum dimensions). The depth of chambers is preferably greatest about the mid-point of the width. Preferably the ratio (of the maximum width of the chambers (in mm) to the maximum depth of the chambers (in mm) is in the ratio of from 1.01:2, more preferably 1.05:1.5, most preferably 1.1:1.35, such as 1.15:1.25. It is preferred that the chambers have a substantially triangular cross-section. Although a rectangular cross section of the chambers are also possible this are less preferred than a substantially triangular cross-section.

The chambers preferably terminate in a face which is adjacent the circumferential flange of the intermediate container. The terminating face is preferably angled relative to the circumferential flange so that it is substantially perpendicular to the circumferential flange. More preferably the terminating face defines an obtuse angle with respect to the circumferential flange.

It is preferred that an aperture is formed in a terminating face of at least one chamber of the container. Most preferably an aperture is formed in at least one terminating face of each chamber and most preferably an aperture is formed in each terminating face of each chamber of the container. A supplemental aperture may also be formed in the main face of one or more chamber(s), e.g. at a mid-point thereof, as desired.

Usually the chambers of the intermediate and final containers are arranged in a regular pattern such as being parallel to each other, e.g. in a row. Preferably the chambers are arranged in a row such that the longest section of a first chamber is adjacent the longest section of a second chamber and so on. The containers generally comprises from 5 to 50 chambers, preferably from 7 to 40, more preferably from 10 to 30, e.g. 12 to 20 such as 12 chambers arranged in such a manner. By the use of a thermoforming manufacturing process it has been found that the gap between each chamber in the container may be relatively small. This provides the benefits that the overall size of the container can be controlled to be as small as possible and that the amount of waste/under-used material in the container is also controlled.

Generally the supporting means used in step b) of the process of the invention comprises a plurality of, preferably connected, members which in use are arranged such that each chamber of the intermediate container associates with at least one member of the supporting means. Generally the members of the supporting means are configured so that their shape is complementary to the chambers of the intermediate container. It is generally preferred that the members are rod-like in shape.

Usually the support means is arranged with its members positioned relative to the intermediate container such that the means are adjacent to an opposite face of the intermediate container surface to the face towards which an aperture making means (used in step d of the process) is advanced. For example a support member may be located so that it is adjacent a face inside a chamber of the intermediate container whereas the aperture making means is advanced to outside chamber of the intermediate container or vice-versa. In this way it has been found that support of the intermediate container during the aperture making process in step d) is most effective in terms of assuring its position relative to the aperture-making means and preventing its distortion during the aperture making process.

Generally in step (d) the aperture is formed by a means comprising a drill, punch or a blade etc.

In one embodiment of the invention the aperture-making means employed is a blade. In this embodiment the intermediate container preferably comprises a projection which is removed by the blade to form the aperture. It is most preferred that the projection is disposed upon a chamber (for example on each chamber) of the intermediate container. Preferably the blade is operated by being moved parallel to a surface of the intermediate container until it abuts and removes the projection.

Preferably the thermoforming process used to produce the intermediate containers in step a) of the present process uses a form-fit pre-former device to form the chambers of the container. Use of the form-fit pre-former device has the advantage that it provides for effective moulding of the chambers of the container by pushing the material used to form the chambers into the desired shape in the cavity of the mould used to carry out the thermoforming process.

In addition to the use of the form-fit pre-former device in the thermoforming process of step a) either air under pressure, or, a vacuum can also be used to aid the thermoforming process. When air is used in addition to the form-fit pre-former device, the form-fit pre-former device pushes the material used to form the intermediate container into the cavity of the mould and remains in place whilst air is also forced into the cavity of the mould to finish forming the intermediate container.

The person skilled in the art is fully capable of calculating dimensions for the form fit pre-former according to the following;

dimension of the form fit pre-former (length, breadth or height)=chamber dimension−2×thickness of thermoformed material

Most preferably the form fit pre-former device and the thermoformed material fit substantially flush together in all dimensions with no significant clearance between the two in step a) of the process as this provides for the advantages of;
1) improved ability to produce thermoformed container shapes accurately and with the desired level of detail,
2) better stability of the thermoformed container, and
3) improved accuracy for forming the aperture in the intermediate container in step d) of the present process, all of which contribute to better performance in use of the thermoformed container and to a better quality container.

It is also possible for the form fit pre-former device to be slightly smaller than the material to be thermoformed so that the two do not fit exactly flush together in step a) of the process. However the greater the extent of the clearance between the form fit pre-former device and the thermoformed material the less likely it is that the above advantages will be fully realised. Accordingly it is preferred that there is at most 2 mm clearance between the form fit pre-former device and the thermoformed material in step a), more preferably at most 1 mm clearance, most preferably at most 0.5 mm clearance, such as at most 0.1 mm clearance in any dimension.

During step c) of the present process it is preferred that the supporting means provides sufficient support to the intermediate container to prevent the intermediate container deforming by more than 20% of its dimension in any axis during step (c). More preferably the supporting means provides sufficient support to the intermediate container to prevent it deforming by more than 10% of its dimension in any axis during step (c). Most preferably the supporting means provides sufficient support to the intermediate container to prevent it deforming by more than 5% of its dimension in any axis during step (c).

The foil thickness of the intermediate container, and of the container produced according to the present process, is preferably 100 to 1000 μm, for example 200 to 800 μm, such as 300 to 600 μm.

According to a second aspect of the invention there is provided a container produced according to the method of the first aspect of the invention.

Generally the container is for use in a detergent dispensing operation or device in an automatic washing machine, such as an automatic dishwashing machine. In this employment the aperture aids the flow of wash liquor to release the detergent from the container. The container may form part of a detergent refill system for a detergent dispensing device. It is especially preferred that the container forms part of a detergent dispensing device for an automatic dishwashing machine.

Preferably the chambers of the container are filled with a detergent product. The chamber size is such that each chamber can accommodate approximately 5-50 g of detergent product, such as 10-30 g, e.g. 15-25 g.

Generally the container is formed of a plastics material (such as a thermoplastic material), e.g. polyethylene or polypropylene. It is preferred that the container is substantially insoluble in water at 20° C.

The container may be modified in a further step after or before being filled with detergent. Such further steps may include, for example, the application of a lidding film to the chambers and/or manipulation of the container into a configuration different from that in which it was originally formed.

1. A process for producing a container comprising at least one aperture, the process comprising the steps of:
a) thermoforming a material to produce an intermediate container in a mould,
b) supporting at least a portion of the intermediate container with a supporting means,
c) securing the intermediate container to hold it in a fixed locus in contact with the supporting means,
d) forming at least one aperture in a surface of the intermediate container in an area of the intermediate container adjacent to the portion of the intermediate container supported by the supporting means to produce the container,
wherein the supporting means provides sufficient support to the intermediate container to prevent substantial deformation thereof during at step (d).

2. A process according to claim 1, wherein the mould used to produce the intermediate container in step a) comprises a plurality of recessions and a circumferential planar section.

3. A process according to claim 1 wherein the intermediate container comprises a number of chambers and a circumferential planar section.

4. A process according to claim 1, wherein the supporting means comprises a plurality of members which in use are arranged such that each chamber of the intermediate container associates with at least one member of the supporting means.

5. A process according to claim 1, wherein in step d) the support means is arranged with its members positioned relative to the intermediate container such that the means are adjacent to an opposite face of the intermediate container surface to the face towards which the aperture making means is advanced.

6. A process according to claim 1, wherein in step (d) the aperture is formed by a means comprising a drill, punch or a blade.

7. A process according to claim 6, wherein the aperture means is a blade and the intermediate container comprises a projection which is removed by the blade by form the aperture.

8. A process according to claim 6, wherein the blade operates by being moved parallel to a surface of the intermediate container until it abuts and removes the projection.

9. A process according to claim 1, wherein the thermoforming process uses a form-fit pre-former device to form chambers in the intermediate container.

10. A container produced according to claim 1, wherein the container has at least one chamber.

11. A container according to claim 10, wherein the chamber(s) of the container are filled with a detergent product.

12. A container according to claim 10, wherein the chambers have a maximum depth dimension greater than their maximum width dimension.

13. A container according to claim 11, wherein the chambers have a maximum depth dimension greater than their maximum width dimension.
